(19) United States
(12) Patent Application Publication
(10) Pub. No.: US 2004/0233563 A1
(43) Pub. Date: Nov. 25, 2004

(54) Recording apparatus

(76) Inventors: Hideyuki Wada, Kanagawa-ken (JP); Kazuaki Arai, Kanagawa-ken (JP); Kenichi Itoh, Kanagawa-ken (JP)

Correspondence Address: EDWARDS & ANGELL, LLP, P.O. BOX 55874, BOSTON, MA, 02205, US

(21) Appl. No.: 10/722,039

(22) Filed: Nov. 24, 2003

(30) Foreign Application Priority Data
May 19, 2003 (JP) 2003-140223

(51) Int. Cl. G11B 5/09

(52) U.S. Cl. 360/39

(57) ABSTRACT

A recording apparatus including two hard disk drives for preventing degradation of the signal which can be manufactured at low cost. The recording apparatus includes: two hard disk drives; a mainboard including a control section for controlling read/write of data from/to the hard disk drives; an interface connector for outputting and inputting data, which is written and read to/from the hard disk drives, to/from an exterior; and board side connectors provided on both sides of the mainboard at opposite end of the mainboard from the interface connector, the board side connectors including mating faces pointing opposite direction from the mainboard. The two hard disk drives are provided on both sides of the mainboard substantially parallel with the mainboard, and include interfaces of the hard disk drives at the end nearest to the board side connectors, and the recording apparatus further includes drive connecting members for connecting interfaces of the hard disk drives with the board side connectors.

This patent application claims priority from a Japanese patent application No. 2003-140223 filed on May 19, 2003, the contents of which are incorporated herein by reference.

### BACKGROUND OF THE INVENTION

1. Field of the Invention

The present invention relates to a recording apparatus. More particularly, the present invention relates to a recording apparatus including two or more information recording medium such as hard disk drives.

2. Related Art

Conventionally, in recording apparatuses utilizing such as RAID, when two hard disk drives are to be connected to a mainboard, the hard disk drives and the mainboard are connected to each other via a subboard or flexible cables. (Cf. Products Information, Advanced Technology and Systems Co. and Ltd, http://www.adtx.co.jp/en/pdf/products/axrb-n_e.pdf)

FIG. 1 is a side view showing arrangement of the hard disk drives 18 and the mainboard 11 according to a conventional recording apparatus, such as RAID 1. In the conventional recording apparatus, the hard disk drives 18 electrically connects with the mainboard 11 via a subboard 60 and flexible cables 64. In this case, the conventional recording apparatus further includes drive side connectors 56 and subboard connectors 58 for connecting the hard disk drives 18 to the subboard 60, and cable connectors 62 and 66 for connecting the flexible cables 64 to the subboard 60 and the mainboard 11.

However, according to the above-described conventional technology, there is a problem that the signal in the cables connecting the hard disk drives 18 to a mirror ASIC 12 mounted on the mainboard 11 deteriorates because the length of the cables is long. Moreover, the number of components has to be reduced for cost reduction.

### SUMMARY OF THE INVENTION

Therefore, it is an object of the present invention to provide a recording apparatus which can solve the foregoing problems. The above and other objects can be achieved by combinations described in the independent claims. The dependent claims define further advantageous and exemplary combinations of the present invention.

According to the first aspect of the present invention, there is provided a recording apparatus including two hard disk drives. The recording apparatus includes: a mainboard including a control section for controlling read/write of data from/to the hard disk drives; an interface connector provided at an edge of the mainboard for outputting and inputting data, which is written and read to/from the hard disk drives, to/from an exterior; and board side connectors provided on both sides of the mainboard at opposite edge of the mainboard from the interface connector, the board side connectors including mating faces pointing opposite direction from the mainboard. The two hard disk drives are provided on both sides of the mainboard substantially parallel with the mainboard, and include interfaces of the hard disk drives at the end nearest to the board side connectors. The recording apparatus further includes drive connecting members for connecting interfaces of the hard disk drives with the board side connectors.

The recording apparatus may further include: an accommodation section for accommodating a board unit and drive units, the board unit including the main board, the interface connector and the board side connectors which are assembled in a unit, and the drive units including the hard disk drives and the drive connecting members which are assembled in units; and guides provided in the accommodation unit for respectively guiding the two hard disk drives in a direction substantially parallel with the mainboard.

The two drive units may be substantially the same as each other and provided on both sides of the board unit. Moreover, the guides are provided along paths of insertion and extraction of the drive units into/out of the board side connectors and the drive connecting members.

The drive units may be inserted and extracted into/out of the mainboard along the guides, and a position of each of the guides may be eccentric away from a midpoint of a total thickness of each of the drive units in the perpendicular direction to the mainboard, and the accommodation section may include an opening arranged so that a part of each of the drive units abuts on an edge of the accommodation section when it is inserted along with each of the guides with a reversed orientation. Moreover, the hard disk drives are assembled so that a motor of each of the hard disk drives is provided at a side of the mainboard.

The summary of the invention does not necessarily describe all necessary features of the present invention. The present invention may also be a sub-combination of the features described above.

### BRIEF DESCRIPTION OF THE DRAWINGS

FIG. 1 is a side view showing arrangement of hard disk drives and mainboard of a conventional recording apparatus.

FIG. 2 is a top view of a recording apparatus being assembled in an information processing apparatus.

FIG. 3 is a cross sectional view showing a structure of the recording apparatus.

FIG. 4 is a perspective view of a board unit.

FIG. 5 is a perspective view of drive units being assembled with the board unit.

FIG. 6 is a perspective view of a recording apparatus.

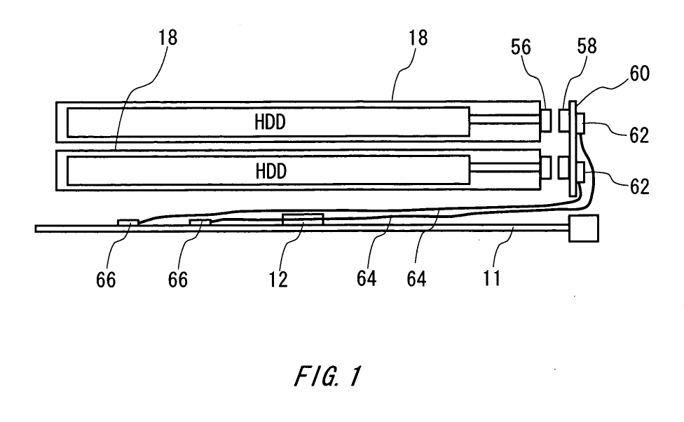

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

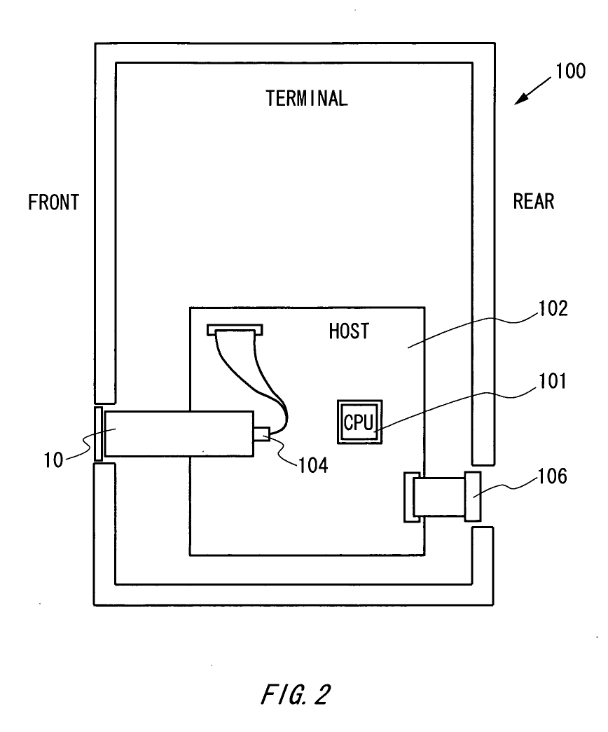

FIG. 2 is a top view of a recording apparatus 10 according to an embodiment of the present invention being assembled in an information processing apparatus 100. For example, the recording apparatus 10 is RAID 1, i.e., a recording apparatus offering improved drive fault tolerance by mirroring of drives. The information processing apparatus 100 is a server, for example, and includes: a host 102 including CPU 101 for issuing commands for reading/writing data to the recording apparatus 10; an interconnection cable 104 for electrically connecting the recording apparatus 10 with the host 102; and an external interface 106 for outputting and inputting data to/from an external device except the recording apparatus 10. The recording apparatus 10 according to the present embodiment prevents degradation of the signal and reduces product cost by a newly devised internal structure.

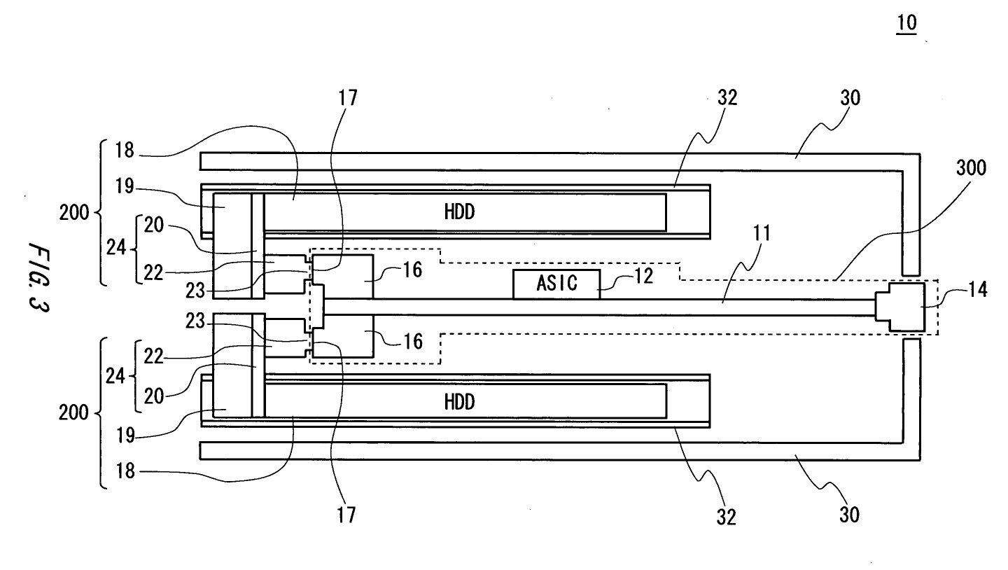

FIG. 3 is a cross sectional view of the recording apparatus 10. The recording apparatus 10 includes: a mainboard 11 including a mirror ASIC 12 for controlling read/write of data from/to hard disk drives 18; an interface connector 14 provided at an end of the mainboard 11 for outputting and inputting data, which is written and read to/from the hard disk drive 18, to/from the exterior; and board side connectors 16 provided on both sides of the mainboard 11 at opposite edge of the mainboard 11 from the interface connector 14, the board side connectors 16 including mating faces 17 pointing opposite direction from the mainboard 11. Here, the mirror ASIC 12 is an example of a control section of the present invention.

The two hard disk drives 18 are provided on both sides of the mainboard 11 substantially parallel with the mainboard 11, and include interfaces of the hard disk drives 18 at the end nearest to the board side connectors 16. The recording apparatus 10 further includes a drive connecting member 24 for connecting interfaces of the hard disk drives 18 with the board side connectors 16. The drive connecting members 24 include: interposers 20 extending substantially perpendicular to the mainboard 11 and confronting both the mating faces 17 and the interfaces of the hard disk drives 18; and drive side connectors 22 fitting the board side connectors 16.

Alternatively, each of the drive connecting members 24 is integrated into a solid part. Here, each of the interposers 20 is a circuit board interposed between the interface of each of the hard disk drives 18 and each of the drive side connectors 22 for relaying the communication between them.

It is preferable that each of the hard disk drives 18 and each of the drive connecting members 24 are fixed to a metal frame for providing rigidity and for easy maintenance.

By the above-described configuration, each of the two hard disk drives 18 electrically connects with the mirror ASIC 12 via each of the drive connecting members 24, each of the board side connectors 16, and the mainboard 11 in that order, and the mirror ASIC 12 electrically connects with the interface connector 14 via the mainboard 11 for data I/O from/to, e.g., the host 102.

That is, according to the recording apparatus 10 which is configured as mentioned above, data is transferable between the hard disk drives 18 and the mirror ASIC 12, without using the conventional flexible cables 64, a conventional back-plane 60, etc. Therefore, the length of the cables from the hard disk drives 18 to the mirror ASIC 12 becomes shorter than the conventional recording apparatus, so that the degradation of the signal is reduced. Moreover, since the number of components is reduced, the cost is also reduced.

Moreover, the mainboard 11, the interface connector 14, and the board side connectors 16 are assembled into one unit, and are included in a board unit 300. On the other hand, each of the drive connecting members 24 and each of the hard disk drives 18 are assembled into one unit, and are included in a drive unit 200. There is provided two drive units 200 of which the structure are substantially the same as each other. The drive units 200 are provided on both sides of the board unit 300. By standardize the two drive units 200, the parts are also standardized and thereby the cost of the drive units 200 is reducible.

The recording apparatus 10 further includes: an accommodation section 3b for accommodating the board unit 300 and the two drive units 200; and guides 32, which is provided in the accommodation unit, for guiding the two hard disk drives 18 in the direction substantially parallel with the mainboard 11. The guides 32 are provided along the paths of insertion and extraction of the drive units 200 into/out of the board side connectors 16 and the drive connecting members 24. Therefore, the board unit 300 and each of the drive units 200 are easily connected or disconnected electrically by inserting or extracting the drive units 200 along the guides 32.

Each of the drive units 200 includes a knob 19 so that each of the drive units 200, which is fully inserted into the recording apparatus 10, is pulled out by human's fingers. By pulling the knob 19 attached on each of the drive units 200, each of the drive units 200 is easily removed from the board unit 300. For example, the knob 19 is fixed to the interposer 20. The knob 19 further includes a locking device (not shown) for locking each of the drive units 200 to the accommodation section 30. The lock of the locking device is released by pulling the knob 19.

Moreover, a position of the guide 32 is eccentric away from the midpoint of the total thickness of the drive unit 200 in the perpendicular direction to the mainboard 11, and the accommodation section 30 includes an opening arranged so that a part of the drive unit 200 abuts on an edge of the accommodation section 30 when it is inserted along with the guide 32 with a reversed orientation. Thereby, improper insertion of the drive unit 200 is prevented. By preventing the improper insertion, damage of the parts is avoided and usability for a user also improves further.

In each of the hard disk drives 18, a motor for rotating the hard disk generates heat the most. In the recording apparatus 10, there is provided a clearance more than the height of the board side connector 16 and the drive side connector 22 between each of the hard disk drives 18 and the mainboard 11. Therefore, plenty spaces for heat dissipation are provided by providing the motor of each of the hard disk drives 18 at the side of the mainboard 11. Thereby, the heat from the recording apparatus 10 is properly dissipated without depending on such as the position of the recording apparatus 10 in the information processing apparatus 100.

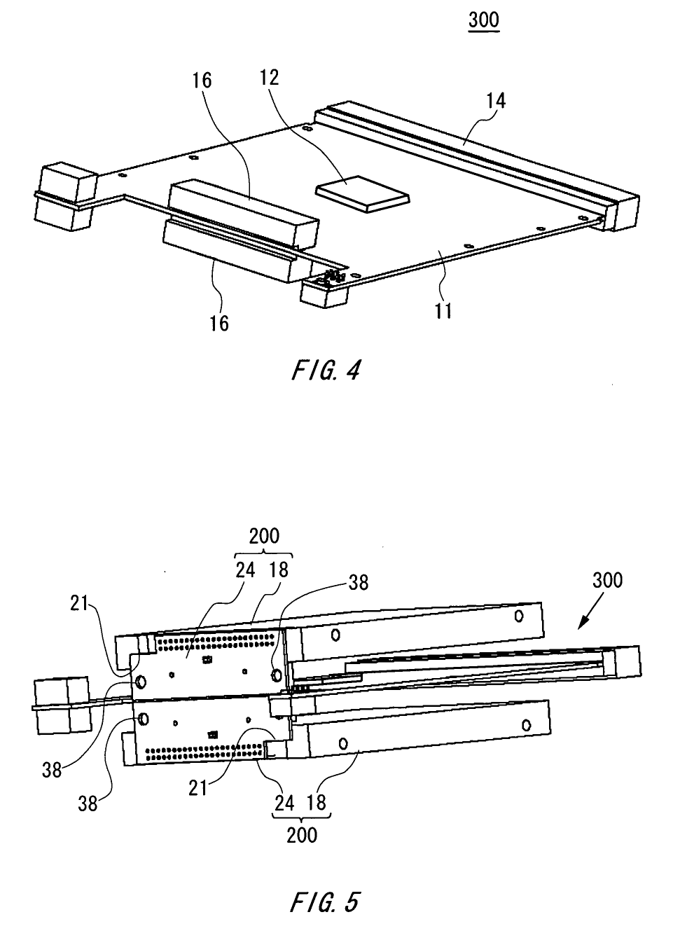

FIG. 4 is a perspective view of the board unit 300. In the present embodiment, two board side connectors 16 are mounted on both sides of the mainboard 11. However, the configuration of the board side connectors 16 is not limited to it, but may be an integrated card edge connector for allowing insertion of an edge of the mainboard 11 for electrically connecting double-sided patterns of the mainboard 11 and the card edge connector. By substituting the card edge connector for the two board side connectors 16, the number of components is reduced and the cost is also reduced.

FIG. 5 is a perspective view of the drive units 200 being assembled with the board unit 300. In FIG. 5, the knobs 19 are removed from the drive units 200. Each of the drive connecting members 24 of the present embodiment includes a substantially rectangular notch 21. The knobs 19 are assembled to the drive connecting members 24 after direction and the position have been correctly adjusted by the notch 21, and screwed from the side of the mainboard 11 through screw holes 38.

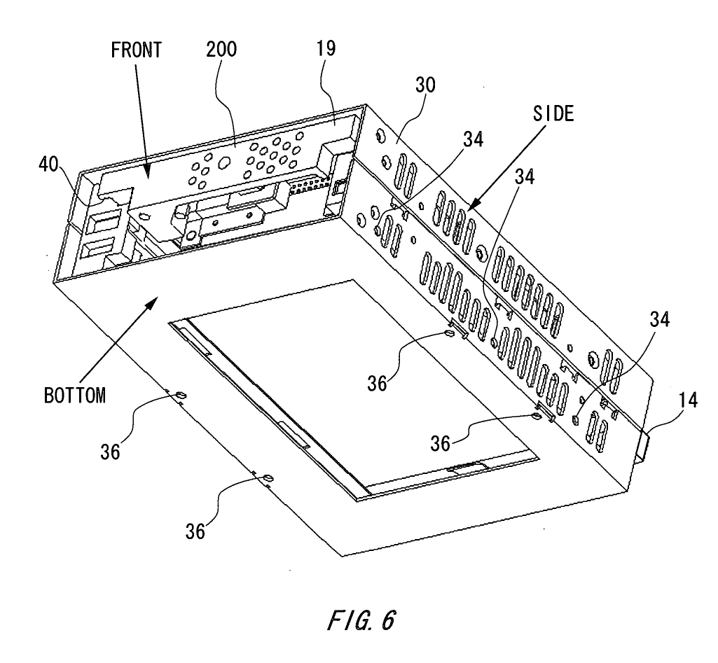

FIG. 6 is a perspective view of the recording apparatus 10. In the recording apparatus 10 shown in FIG. 6, one of the drive units 200 is removed from the recording apparatus 10. The accommodation section 30 includes side screw holes 34 and bottom screw holes 36 for fixing either the side or the bottom of the recording apparatus 10 in the information processing apparatus 100 etc. There are provided openings for dissipating the heat generated in the drive unit 200 and the board unit 300 on the side and the bottom of the accommodation section 30. If needed, each of the knobs 19 includes an ear 40 on the opposite end from the front of the drive unit 200 for engaging human's fingers for easy insertion and extraction of the drive unit 200.

As described above, according to the present embodiment of the invention, there is provided the recording apparatus 10 for preventing degradation of the signal which can be manufactured at low cost.

Although the present invention has been described by way of an exemplary embodiment, it should be understood that those skilled in the art might make many changes and substitutions without departing from the spirit and the scope of the present invention which is defined only by the appended claims.

What is claimed is:

1. A recording apparatus comprising:
at least two recording medium;
a mainboard including a control section for controlling read/write of data from/to the recording medium;
an interface connector provided at an edge of said mainboard for outputting and inputting data, which is written and read to/from the recording medium, to/from an exterior; and
board side connectors provided on both sides of said mainboard at opposite edge of said mainboard from said interface connector, said board side connectors including mating faces pointing opposite direction from said mainboard, wherein
the two recording medium are provided on both sides of said mainboard substantially parallel with said mainboard, and include interfaces of the recording medium at the end nearest to said board side connectors, and
the recording apparatus further comprises drive connecting members for connecting interfaces of the recording medium with said board side connectors.

2. The recording apparatus as claimed in claim 1, further comprising:
an accommodation section for accommodating a board unit and drive units, the board unit including said main board, said interface connector and said board side connectors which are assembled in a unit, and the drive units including the recording medium and said drive connecting members which are assembled in units; and
guides provided in said accommodation unit for respectively guiding the two recording medium in a direction substantially parallel with said mainboard.

3. The recording apparatus as claimed in claim 2, wherein the two drive units are substantially the same as each other and provided on both sides of the board unit.

4. The recording apparatus as claimed in claim 2, wherein said guides are provided along paths of insertion and extraction of the drive units into/out of said board side connectors and said drive connecting members.

5. The recording apparatus as claimed in claim 2, wherein
a position of each of said guides is eccentric away from a midpoint of a total thickness of each of the drive units in the perpendicular direction to said mainboard, and
said accommodation section comprises an opening arranged so that a part of each of the drive units abuts on an edge of said accommodation section when it is inserted along with each of said guides with a reversed orientation.

6. The recording apparatus as claimed in claim 1, wherein the recording medium are assembled so that a motor of each of the recording medium is provided at a side of said mainboard.

7. The recording apparatus as claimed in claim 1, wherein the recording medium comprises a hard disk drive.
